(19) United States
(12) Patent Application Publication
(10) Pub. No.: US 2024/0199149 A1
(43) Pub. Date: Jun. 20, 2024

(54) Continuous Track With End Connector Removal System

(71) Applicant: Erni Jay Lombard, Beaumont, TX (US)

(72) Inventor: Erni Jay Lombard, Beaumont, TX (US)

(21) Appl. No.: 18/082,183

(22) Filed: Dec. 15, 2022

(51) Int. Cl. B62D 55/32; B62D 55/06; B62D 55/21

(52) U.S. Cl. CPC B62D 55/32; B62D 55/06; B62D 55/21

(57) ABSTRACT

A continuous track with end connector removal system for removing a pair of end connectors includes a battle tank having a frame and a pair of continuous tracks is rotatably attached to the frame. Each continuous track comprises a plurality of track pads being removably coupled to each other and being positioned successively along each continuous track. A plurality of end connectors removably secures the track pads together and a track extractor assembly pushes a pair of end connectors away from the track pads, wherein the track extractor assembly simultaneously removes the pair of end connectors from the track pads.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to endless track tool and more particularly pertains to a new endless track tool for removing a pair of end connectors.

### (2) Description of Related Art Including Information Disclosed Under 37 CFR 1.97 and 1.98

The prior art relates to endless track tools and includes a variety of tools facilitating in removing an endless track from a vehicle. Known prior art does not include an endless track tool facilitating in removing a pair of end connectors of the track simultaneously.

### (h) BRIEF SUMMARY OF THE INVENTION

An embodiment of the disclosure meets the needs presented above by generally comprising a battle tank having a frame and a pair of continuous tracks is rotatably attached to the frame. Each continuous track comprises a plurality of track pads being removably coupled to each other and being positioned successively along each continuous track. A plurality of end connectors removably secures the track pads together and a track extractor assembly is configured for pushing a pair of end connectors away from the track pads, wherein the track extractor assembly simultaneously removes the pair of end connectors from the track pads.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a continuous track with end connector removal system according to an embodiment of the disclosure.

FIG. 2 is a front view of an embodiment of the disclosure.

FIG. 3 is a side view of an embodiment of the disclosure.

FIG. 4 is an exploded view of an embodiment of the disclosure.

FIG. 5 is an in-use view of an embodiment of the disclosure.

FIG. 6 is a detail view of an embodiment of the disclosure.

FIG. 7 is an in-use view of an embodiment of the disclosure.

### (j) DETAILED DESCRIPTION OF THE INVENTION

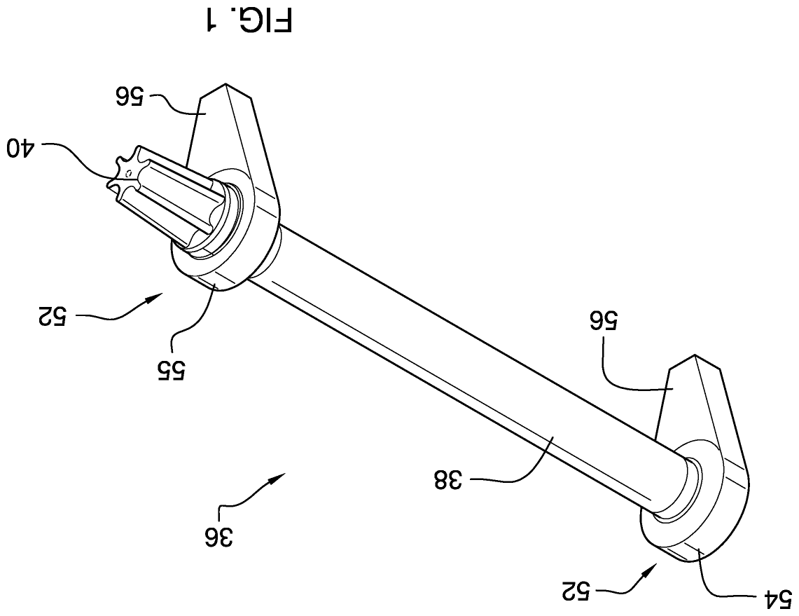

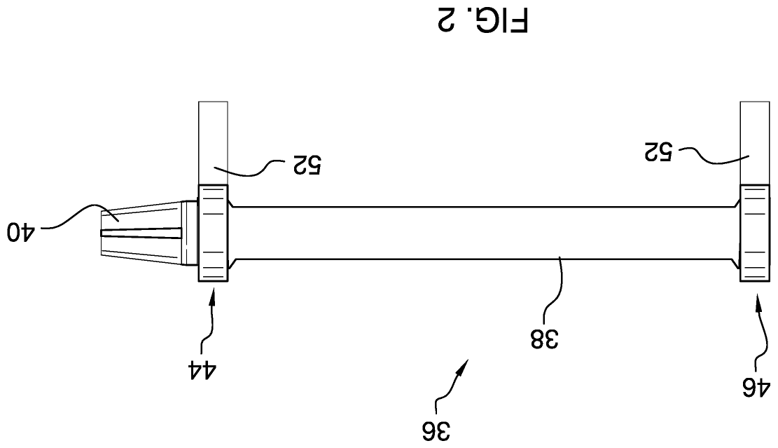

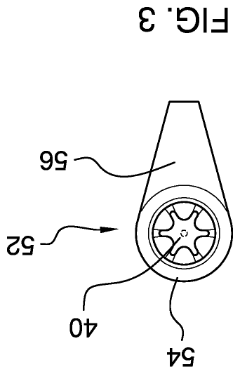

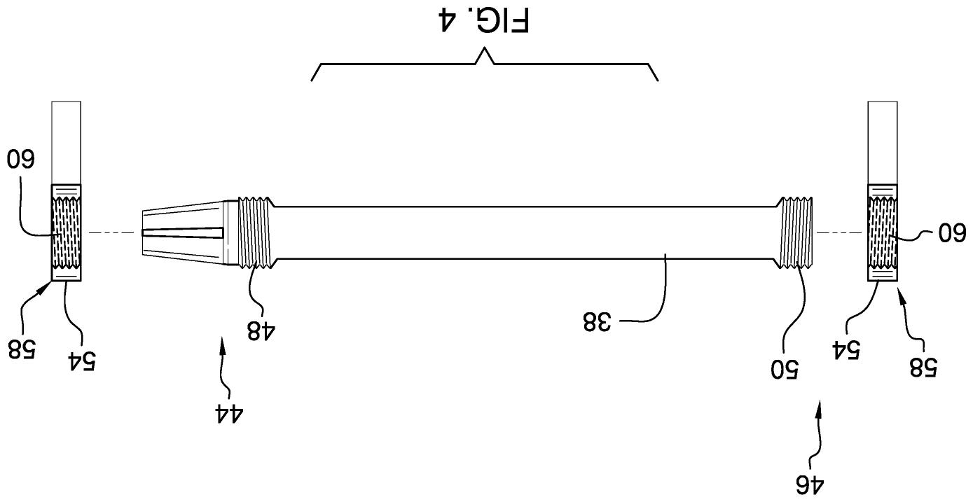

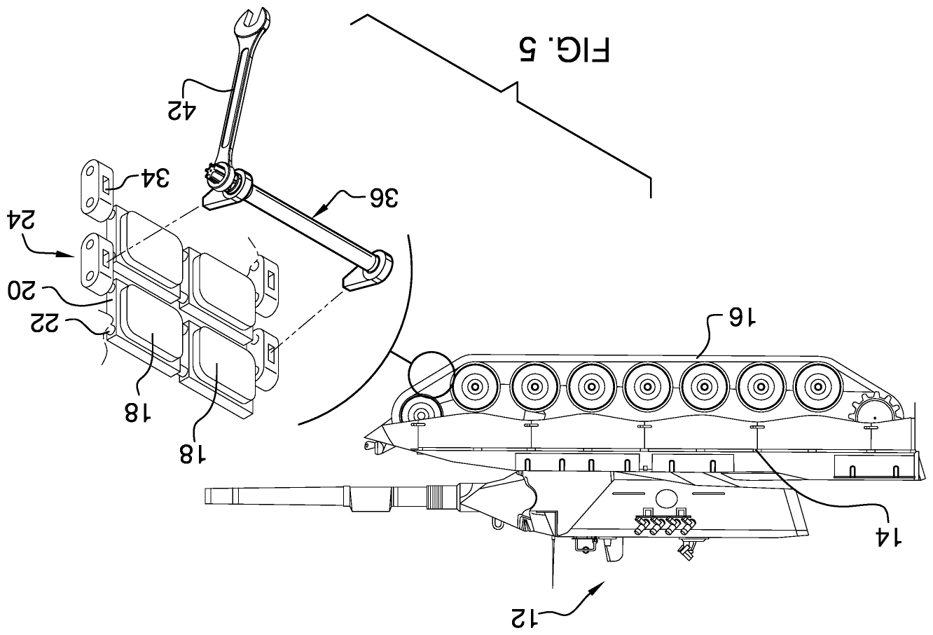

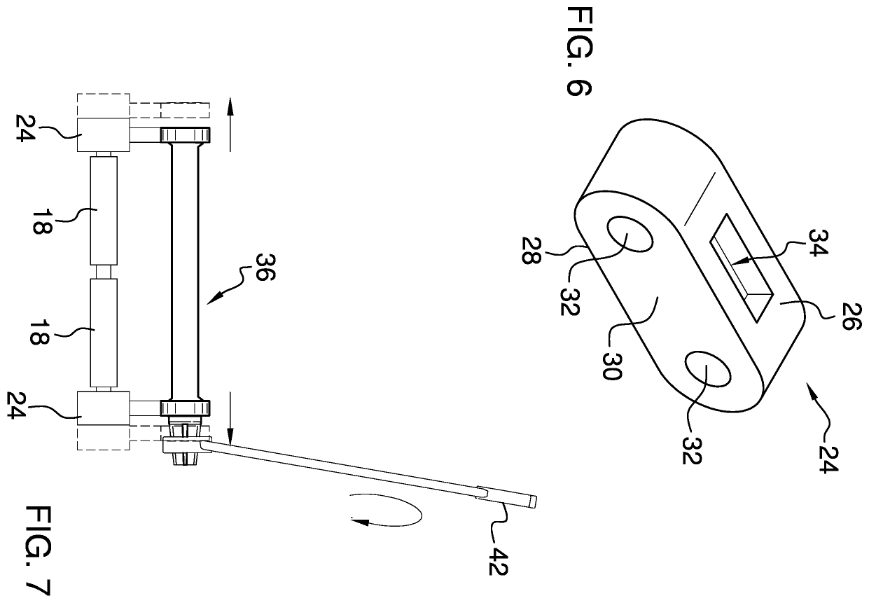

With reference now to the drawings, and in particular to FIGS. 1 through 7 thereof, a new endless track tool embodying the principles and concepts of an embodiment of the disclosure and generally designated by the reference numeral 10 will be described.

As best illustrated in FIGS. 1 through 7, the continuous track with end connector removal system 10 generally comprises a battle tank 12 having a frame 14 and a pair of continuous tracks 16 is rotatably attached to the frame 14. Each continuous track 16 comprises a plurality of track pads 18 removably coupled to each other and positioned successively along each continuous track 16. Each track pad 18 has a pair of side edges 20 being positioned flush to each other. A pair of connecting pins 22 is positioned on each one of the side edges 20 of each track pad 18.

A plurality of end connectors 24 removably secures the track pads 18 together. Each end connector 24 has a top side 26, a bottom side 28, and a pair of lateral sides 30. A pair of apertures 32 is typically positioned on and extending through the lateral sides 30. The apertures 32 of each end connector 24 removably receives one of the connecting pins 22 of each track pad 18 and secure each track pad 18 to a neighboring track pad 18. The top side 26 of each end connector 24 normally has a pocket extending through and defines a receiving space 34.

A track extractor assembly 36 is configured for pushing a pair of end connectors 24 away from the track pads 18, wherein the track extractor assembly 36 simultaneously removes the pair of end connectors 24 from the track pads 18. The track extractor assembly 36 includes a breaker bar 38 having a hex nut 40 configured for engaging with a ratcheting wrench 42, wherein the ratcheting wrench 42 rotates the breaker bar 38 when the ratcheting wrench 42 rotates. The breaker bar 38 includes a first end 44 and a second end 46. The first end 44 has a right-handed exterior threading 48 and the second end 46 has a left-handed exterior threading 50.

A pair of extraction members 52 is removably secured to the breaker bar 38 and removably engages with the pair of end connectors 24. Each extraction member 52 comprises a base 54 and a protrusion 56 is attached to and extending from the base 54. The protrusion 56 is removably inserted within the receiving space 34 of each end connector 24. The base 54 has a hole extending through the base 54 and defines a breaker bar receiving space 58. The breaker bar receiving space 58 has an interior threading 60 such that the base 54 of each extraction member 52 is threadably engaged to the first 44 and second 46 ends of the breaker bar 38, wherein each extraction member 52 is moved away from each other when the breaker bar 38 rotates.

In use, the pair of extraction members 52 is threadably secured to the first 44 and second 46 ends of the breaker bar 38. The protrusion 56 of each extraction members 52 are inserted within the receiving space 34 of each end connector 24 of the pair of end connectors. The ratcheting wrench 42 is coupled to the hex nut 40 and the breaker bar 38 rotates when the ratcheting wrench 42 rotates. As the breaker bar 38 rotates, each of the extraction members 52 begins to move outwardly from each other, wherein the extraction members 52 move the end connectors 24 outwardly from the connecting pins 22 of the track pads 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A continuous track with end connector removal system comprising:
a battle tank having a frame;
a pair of continuous tracks being rotatably attached to said frame, each continuous track comprising a plurality of track pads being removably coupled to each other and being positioned successively along each continuous track;
a plurality of end connectors removably securing said track pads together; and
a track extractor assembly being configured for pushing a pair of end connectors away from said track pads, wherein said track extractor assembly simultaneously removes said pair of end connectors from said track pads.

2. The continuous track with end connector removal system of claim 1, wherein each track pad has a pair of side edges, said side edges of each track pad being positioned flush to each other, a pair of connecting pins being positioned on each one of said side edges of each track pad.

3. The continuous track with end connector removal system of claim 2, wherein each end connector has a top side, a bottom side, and a pair of lateral sides, a pair of apertures being positioned on and extending through said lateral sides, said apertures of each end connector removably receiving one of said connecting pins of each track pad and securing each track pad to a neighboring track pad.

4. The continuous track with end connector removal system of claim 3, wherein said top side of each end connector has a pocket extending through and defines a receiving space.

5. The continuous track with end connector removal system of claim 1, wherein said track extractor assembly includes a breaker bar having a hex nut and is configured for engaging with a ratcheting wrench, wherein said ratcheting wrench rotates said breaker bar when said ratcheting wrench rotates.

6. The continuous track with end connector removal system of claim 5, wherein said breaker bar includes a first end and a second end, said first end having a right-handed exterior threading, said second end having a left-handed exterior threading.

7. The continuous track with end connector removal system of claim 6, further including a pair of extraction members being removably secured to said breaker bar and removably engaging with said pair of end connectors.

8. The continuous track with end connector removal system of claim 7, wherein each extraction member comprises a base and a protrusion being attached to and extending from said base, said protrusion being removably inserted within said receiving space of each end connector, said base having a hole extending through said base and defining a breaker bar receiving space, said breaker bar receiving space having an interior threading, said base of each extraction member is threadably engaged to said first and second ends of said breaker bar, wherein each extraction member is moved away from each other when said breaker bar rotates.

9. A continuous track with end connector removal system comprising:
a battle tank having a frame;
a pair of continuous tracks being rotatably attached to said frame, each continuous track comprising a plurality of track pads being removably coupled to each other and being positioned successively along each continuous track, each track pad having a pair of side edges, said side edges of each track pad being positioned flush to each other, a pair of connecting pins being positioned on each one of said side edges of each track pad;
a plurality of end connectors removably securing said track pads together, each end connector having a top side, a bottom side, and a pair of lateral sides, a pair of apertures being positioned on and extending through said lateral sides, said apertures of each end connector removably receiving one of said connecting pins of each track pad and securing each track pad to a neighboring track pad, said top side of each end connector having a pocket extending through and defining a receiving space;
a track extractor assembly being configured for pushing a pair of end connectors away from said track pads, wherein said track extractor assembly simultaneously removes said pair of end connectors from said track pads, said track extractor assembly including:
a breaker bar having a hex nut and being configured for engaging with a ratcheting wrench, wherein said ratcheting wrench rotates said breaker bar when said ratcheting wrench rotates, said breaker bar including a first end and a second end, said first end having a right-handed exterior threading, said second end having a left-handed exterior threading;
a pair of extraction members being removably secured to said breaker bar and removably engaging with said pair of end connectors, each extraction member comprising a base and a protrusion being attached to and extending from said base, said protrusion being removably inserted within said receiving space of each end connector, said base having a hole extending through said base and defining a breaker bar receiving space, said breaker bar receiving space having an interior threading, said base of each extraction member is threadably engaged to said first and second ends of said breaker bar, wherein each extraction member is moved away from each other when said breaker bar rotates.
